(19) United States
(12) Patent Application Publication
(10) Pub. No.: US 2005/0068336 A1
(43) Pub. Date: Mar. 31, 2005

(54) Image overlay apparatus and method for operating the same

(76) Inventors: Phil Van Dyke, Surrey (CA); Raymond Chow, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/672,388

(22) Filed: Sep. 26, 2003

(51) Int. Cl. G09G 5/00

(52) U.S. Cl. 345/629

(57) ABSTRACT

Broadly speaking, an image overlay apparatus and corresponding method of operation are provided. More specifically, the image overlay apparatus and corresponding method of operation combine multiple sets of display data in an efficient manner while eliminating storage of additional display data in a display memory. Key data is written to the display memory to define a portion of the viewable area of the display component that will be used for rendering an incoming set of display data. The key data is modified using appropriate portions of the incoming set of display data. Modification of the key data using the incoming set of display data can be performed during residence of the key data in the display memory or during transmission of the key data to a display component.

### BACKGROUND OF THE INVENTION

1. Field of the Invention

The present invention relates generally to display of digital image data.

2. Description of the Related Art

Modern display devices are commonly equipped with an ability to display a picture-in-picture window. The picture-in-picture window is used for displaying an overlay image on a background image. For example, the background image may represent a desktop view of a computing system, and the overlay image (i.e., picture-in-picture window) may represent an image captured by a digital camera. Traditionally, to display the overlay image on the background image, separate portions of display memory are required. One portion of display memory is required for a main window, and another portion of display memory is required for a sub-window. The portion of display memory for the main window contains display data for the entire background image, and the portion of display memory for the sub-window contains display data for the overlay image. The background image data is retrieved from the main window portion of display memory and displayed. Then, the overlay image data is retrieved from the sub-window portion of display memory and displayed over a portion of the background image.

With the traditional technique for displaying the overlay image on the background image, the display memory is required to be large enough to accommodate data for both the entire main window (i.e., entire background image) and the sub-window (i.e., overlay image). A set of pixels used to define the display image will have two sets of data stored in the display memory: a first set of data for display in a context of the main window and a second set of data for display in a context of the sub-window. Therefore, additional display data is stored in the display memory for each pixel defining the sub-window display area.

A larger display memory requires more silicon space for implementation and consumes more power during operation. Also, the larger display memory increases an overall device cost. Furthermore, since storage of additional display data is required for a each pixel within the sub-window display area, it is necessary to implement separate sub-window functionality (i.e., logic) for determining boundaries that are indicative of which portion of memory (i.e., that containing main window display data or that containing sub-window display data) to retrieve data from for a given pixel.

In view of the foregoing, there is a need for an apparatus and method that will provide for overlaying of image data without requiring storage and retrieval of additional display data.

### SUMMARY OF THE INVENTION

Broadly speaking, the present invention fills these needs by providing an image overlay apparatus and corresponding method of operation. More specifically, the present invention provides for combining multiple sets of display data in an efficient manner while utilizing a display memory having a capacity to store one complete set of display data for an entire viewable area of a display component. In the present invention, key data is written to the display memory to define a portion of the viewable area of the display component that will be used for rendering an incoming set of display data. The portion of the viewable area of the display component used for rendering the incoming display data can be defined as a picture-in-picture window. The incoming display data can represent a stand-alone image (e.g., picture) or a sequence of images (e.g., video). The apparatus of the present invention can be operated in either of two modes: snapshot mode and view mode. When operated in snapshot mode, the present invention overwrites the key data within the display memory with the incoming stand-alone image display data, prior to transmission of the display data to the display component. When operated in view mode, the present invention does not require that the display data for the incoming sequence of images be written to the display memory. Rather, in view mode, the present invention uses the display data of the incoming sequence of images to modify the key data as the display data is transmitted to the display component. Thus, in view mode, the key data remains stored in the display memory for use with each incoming frame representing the sequence of images.

In one embodiment, an image overlay apparatus is disclosed. The image overlay apparatus includes a memory for storing a first set of display data. The first set of display data includes a set of key data associated with a key data value. The image overlay apparatus also includes an input for receiving a second set of display data and an output for transmitting a set of output display data. A comparison component of the image overlay apparatus is configured to compare a portion of the first set of display data to the key data value to determine whether the portion of the first set of display data is to be modified. If the portion of the first set of display data is to be modified, the modification is performed with a corresponding portion of the second set of display data.

In another embodiment, a display controller is disclosed. The display controller includes a memory region configured to store display data within which key data is integrated. The display controller also includes comparison circuitry that is configured to receive both image overlay data and the display data from the memory region. The image overlay data is received from a source external to the memory region. Both the image overlay data and the display data are received by the comparison circuitry in accordance with a synchronization signal. The comparison circuitry is further configured to modify the key data using the image overlay data during transmission of the display data to a display panel.

In another embodiment, a method for operating an image overlay apparatus is disclosed. The method includes establishing a portion of a first set of display data as key data, wherein the key data is defined by a key data value. The method also includes receiving a second set of display data defining an image of a given shape and size. The method further includes comparing a portion of the first set of display data to the key data value. The portion of the first set of display data that is compared to the key data value represents an equivalent shape and size of the image defined by the second set of display data. The method continues with modifying the key data within the portion of the first set of display data using corresponding portions of the second set of display data. The method also includes transmitting the first set of display data to a display component.

Other aspects of the invention will become more apparent from the following detailed description, taken in conjunction with the accompanying drawings, illustrating by way of example the present invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a high-level architecture of a device for displaying digital image data, in accordance with one embodiment of the present invention;

FIG. 2 is an illustration showing architectural features of the display controller that are used for displaying snapshot data within a specified portion of the viewable area of the display component, in accordance with one embodiment of the present invention;

FIG. 3 is an illustration showing architectural features of the display controller that are used for displaying view data within a specified portion of the viewable area of the display component, in accordance with one embodiment of the present invention;

FIG. 4 is an illustration showing architectural features of the display controller used to combine snapshot mode and view mode functionality, in accordance with one embodiment of the present invention; and

FIG. 5 shows a flowchart illustrating a method for operating an image overlay apparatus, in accordance with one embodiment of the present invention.

### DETAILED DESCRIPTION

Broadly speaking, an invention is disclosed for an image overlay apparatus and corresponding method of operation. More specifically, the present invention provides an apparatus and method for combining multiple sets of display data in an efficient manner that optimizes memory usage. It should be appreciated that the present invention can be implemented in numerous ways, including as a process, an apparatus, a system, a device, or a method. Several exemplary embodiments of the invention will now be described in detail with reference to the accompanying drawings.

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

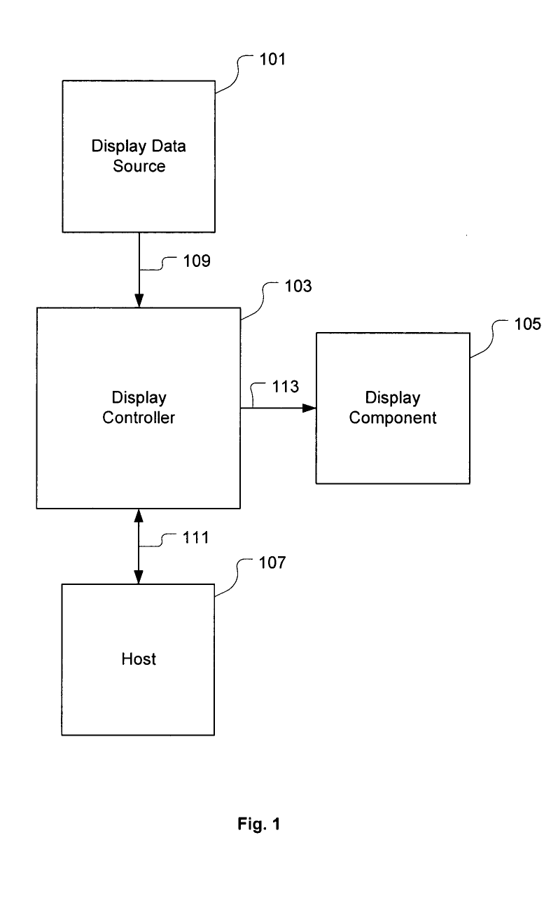

FIG. 1 is an illustration showing a high-level architecture of a device for displaying digital image data, in accordance with one embodiment of the present invention. The device includes a display controller 103, a microprocessor unit (MPU) host 107, a display component 105, and a display data source 101. The display controller 103 is defined and operated to control a transmission of display data to the display component 105 as indicated by an arrow 113. The MPU host 107 is defined and operated to perform digital processing operations. The MPU host 107 and display controller 103 are capable of communicating with each other as indicated by an arrow 111. The display data source 101 provides the display controller 103 with a set of display data as indicated by an arrow 109. In various embodiments, the display data source 101 can be a digital video camera, a digital camera, an electromagnetic transmission, a digital data storage device, or an external MPU host, among others. Depending on the particular embodiment, the display controller 103 can be configured with a data port, a network interface card, or an antenna, among others, to receive the set of display data provided from the display data source 101. Additionally, the display controller 103 can be configured to receive the set of display data in any format. For example, the set of display data may be in any suitable digital format, which includes various color formats, among others. In one embodiment, the set of display data is transmitted in digital format after having been captured and processed by digital imaging circuitry. In another embodiment, the set of display data is transmitted in digital format after having been converted from JPEG format by a JPEG CODEC. In yet another embodiment, the set of display data is transmitted in YUV format from an MPU host either associated with or external to the device for displaying digital image data.

The display controller 103 is configured to operate in two modes: 1) snapshot mode; and 2) view mode. In snapshot mode, the set of display data received by the display controller 103 represents a single frame of image data. The single frame of image data contains data for each pixel within a portion of a viewable area of the display component 105. For purposes of discussion in the remainder of this document, the set of display data received by the display controller 103 during operation in snapshot mode is referred to as snapshot data. When operated in snapshot mode, the display controller 103 transmits the snapshot data to the display component 105 to be displayed.

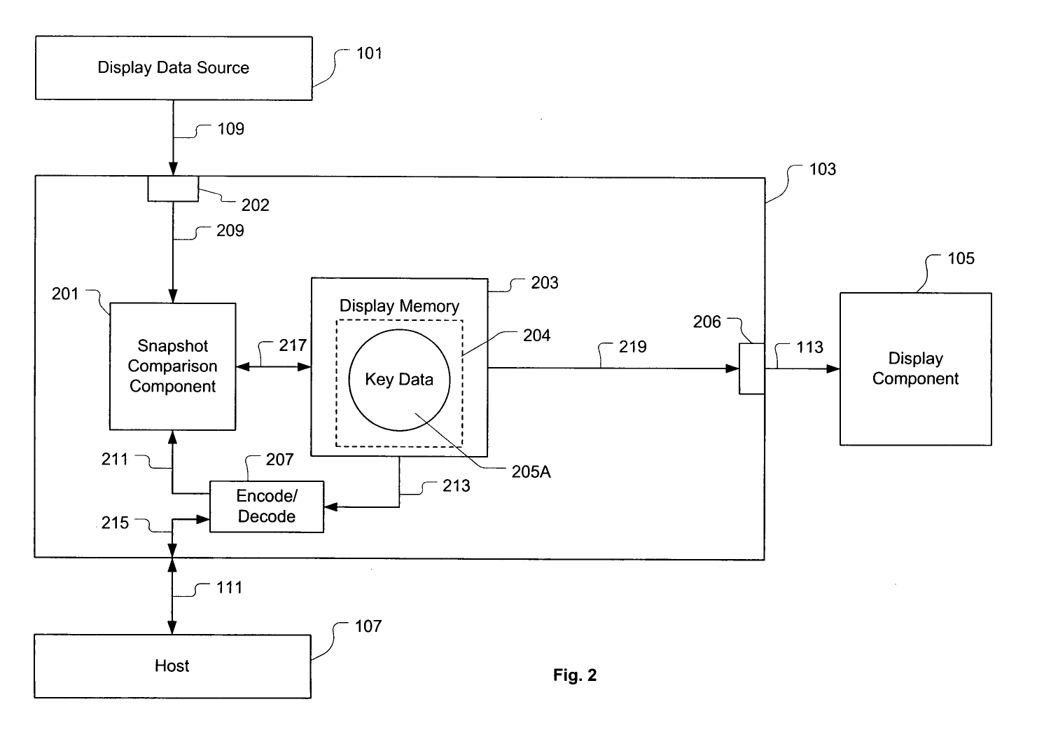

FIG. 2 is an illustration showing architectural features of the display controller 103 that are used for displaying snapshot data within a specified portion of the viewable area of the display component 105, in accordance with one embodiment of the present invention. In one embodiment, the snapshot data represents a single frame of image data provided by a digital camera. In another embodiment, the snapshot data is a single frame of image data obtained from a set of stored image data (e.g., JPEG data) that is decoded for processing and display. It should be understood, however, that the present invention is not limited to receiving the snapshot data from a particular display data source 101. The display controller 103 includes an input module 202 for receiving the snapshot data. The snapshot data is transmitted from the display data source 101 to the input module 202 of the display controller 103 as indicated by the arrow 109. Once received, the snapshot data is communicated to a snapshot comparison component 201 as indicated by an arrow 209. The snapshot comparison component 201 is in two-way communication with a display memory 203 as indicated by an arrow 217. As such, the snapshot comparison component 201 is capable of reading from and writing to the display memory 203.

The display memory 203 is capable of storing image data for each pixel within a coordinate system used to define the viewable area of the display component 105. In snapshot mode, the snapshot data is written to the display memory 203. However, the snapshot data is only written to portions of the display memory 203 containing a designated key data value. For example, in the case where the snapshot data represents a rectangular image, there will be a corresponding portion of the display memory 203 for storing display data capable of defining the complete rectangular image associated with the snapshot data. For purposes of discussion, this corresponding portion of the display memory 203 is referred to as an image overlay area. An example image overlay area 204 is shown within the display memory 203 of FIG. 2. In one embodiment, prior to processing of the snapshot data by the snapshot comparison component 201, the designated key data value is stored for a number of pixels within the image overlay area. The number of pixels for which the designated key data value is stored represents a set of key data that can be defined to form a key data area of variable shape, size, and position. For exemplary purposes, key data area 205A is shown in FIG. 2 to define a circular area. In one embodiment, the user can control the position of the image overlay area with respect to the key data area.

With respect to the example embodiment of FIG. 2, the snapshot comparison component 201 performs a pixel-by-pixel comparison of the data stored in the image overlay area 204 of the display memory 203 with the designated key data value. If the data stored in the image overlay area 204 for a given pixel is equal to the designated key data value, the data stored in the image overlay area for the given pixel will be overwritten with the corresponding snapshot data for the given pixel. Conversely, if the data stored in the image overlay area 204 for a given pixel is not equal to the designated key data value, the data stored in the image overlay area for the given pixel will be retained and the corresponding snapshot data for the given pixel will be discarded or blocked. In this manner, each pixel within the corresponding portion of the display memory 203 that is within the image overlay area 204 is analyzed and processed by the snapshot comparison component 201. With respect to the example of FIG. 2, once processing by the snapshot comparison component 201 is completed, the circular portion of the snapshot data that is coincident with the key data 205A will be stored within the display memory 203. A complete set of display data stored within the display memory 203 is transmitted to an output module 206 of the display controller 103 as indicated by an arrow 219. The display component 105 is capable of receiving the complete set of display data from the output module 206 of the display controller 103 as indicated by the arrow 113. The display component 105 is configured to render the complete set of display data, including the circular portion of the snapshot data. Also, in snapshot mode, since the key data 205A is overwritten in the display memory 203 by the incoming snapshot data, one frame of snapshot data may be displayed at a given time. To display another frame of snapshot data, the key data 205A is rewritten to the display memory 203 prior to processing of the snapshot data by the snapshot comparison component 201. It will be apparent to one skilled in the art that the various components of the display controller 103 can be implemented as electronic circuits using logic gates. For example, snapshot comparison component 201 includes comparators as well as other known circuitry to achieve the functionality described herein.

In one embodiment, the complete set of display data can be transmitted to an encode/decode device 207 as indicated by an arrow 213. The encode/decode device 207 can be an encoding component capable of receiving the complete set of display data and converting the complete set of display data to a digital format suitable for storage. In one embodiment, the encode/decode device 207 is a Joint Photographic Experts Group (JPEG) coder-decoder (CODEC). The JPEG CODEC includes hardware or software for converting display data to JPEG code and vice versa. Thus, the JPEG CODEC is capable of converting the complete set of display data to a JPEG format suitable for storage on a computer readable media. After being converted to the digital format suitable for storage, the complete set of display data can be transmitted to the MPU host 107, as indicated by arrows 215 and 111, for storage or further processing. Also, as indicated by arrows 215 and 111, the encode/decode device 207 is capable of receiving and decoding JPEG formatted data from the MPU host 107. The decoded JPEG data can be transmitted from the encode/decode device 207 to the snapshot comparison component 210 for processing in the manner previously discussed. Thus, in one embodiment, the JPEG data can serve as the display data source.

In one embodiment, the designated key data value is represented as a data value mapped to a color (i.e., RGB value). In this embodiment, the designated key data value is referred to as a key color. In one embodiment, the key color is user specified. Key data specifications (i.e., color value, shape, size, and position in the viewable area of the display component 105) can be specified by the user through the MPU host 107 and stored in internal registers within the display controller 103. The shape, size, and position of the key data area (i.e., key color area) is variable. Thus, the key data area can be defined to allow the snapshot data to be displayed in any suitable shape (e.g., square, heart, cloverleaf, etc . . . ), size, and position in the viewable area of the display component 105.

When the display controller 103 is operated in view mode, the set of display data received by the display controller 103 represents multiple frames of image data transmitted in a particular sequence at a particular rate. For example, in one embodiment, the multiple frames of image data correspond to a digital video stream. For purposes of discussion in the remainder of this document, the set of display data received by the display controller 103 during operation in view mode is referred to as view data. When operated in view mode, the display controller 103 transmits the view data in an appropriate sequence and at an appropriate rate to the display component 105 to be displayed.

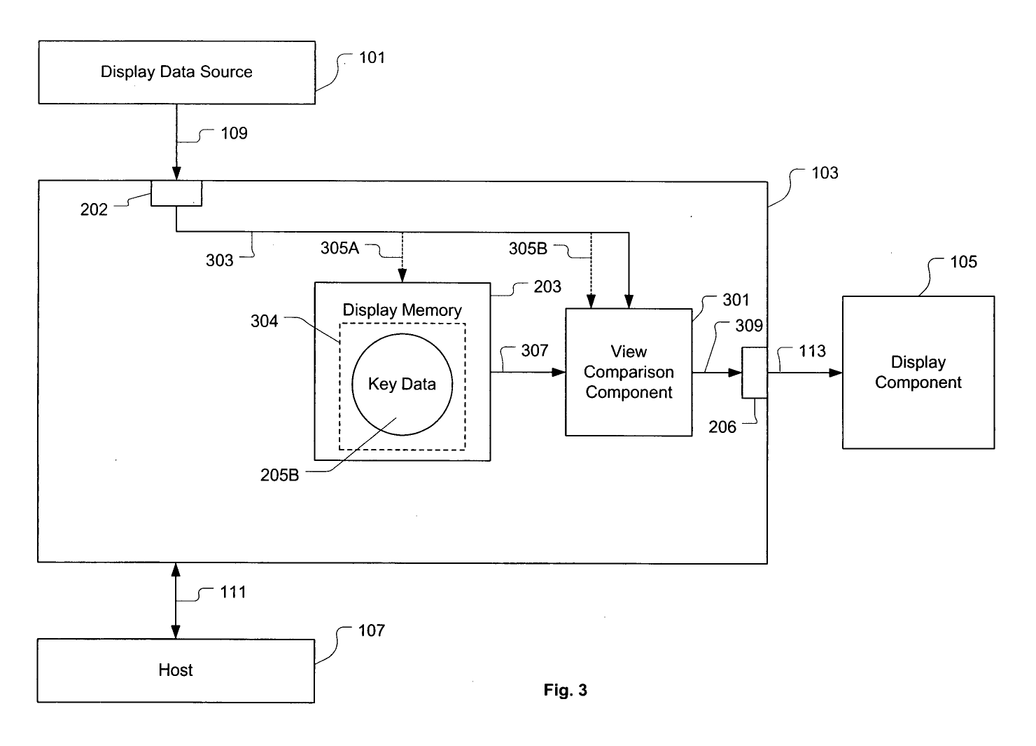

FIG. 3 is an illustration showing architectural features of the display controller 103 that are used for displaying view data within a specified portion of the viewable area of the display component 105, in accordance with one embodiment of the present invention. In one embodiment, the view data represents a digital video stream including multiple frames of image data transmitted sequentially from a digital video camera. In another embodiment, the view data represents a digital video stream obtained from a set of stored video data that is decoded for processing and display. It should be understood, however, that the present invention is not limited to receiving the view data from a particular display data source 101. The view data is received by the display controller 103 at the input module 202. The view data is transmitted from the display data source 101 to the input module 202 of the display controller 103 as indicated by the arrow 109. Once received, the view data is communicated to a view comparison component 301 as indicated by an arrow 303. The view comparison component 301 is in communication with the display memory 203 as indicated by an arrow 307. As such, the view comparison component 301 is capable of reading from the display memory 203.

As previously described, the display memory 203 is capable of storing image data for each pixel within the coordinate system used to define the viewable area of the display component 105. Unlike snapshot mode, in view mode the view data is not written to the display memory 203. Rather, the view data is used to modify designated key data during transmission of the complete set of display data from the display memory 203 to the display component 105. In one embodiment, modification of the key data is performed by replacing the key data with corresponding view data. In another embodiment, modification of the key data includes performing logical operations with the display data and the key data. Examples of the logical operations that can be performed include AND, OR, XOR, AVG, BITSHIFT LEFT, BITSHIFT RIGHT, among others. It should be appreciated by those skilled in the art that modification of the key data can be achieved by performing other logical operations not explicitly exemplified. For example, in the case where the view data represents a sequence of rectangular images (i.e., frames), there will be a corresponding portion of the display memory 203 for storing display data capable of defining the complete rectangular image associated with each frame of the view data. For purposes of discussion, this corresponding portion of the display memory 203 is referred to as a frame overlay area. An example frame overlay area 304 is shown within the display memory 203 of FIG. 3. In one embodiment, prior to processing of the view data by the view comparison component 301, the designated key data value is stored for a number of pixels within the frame overlay area. The number of pixels for which the designated key data value is stored represents a set of key data that can be defined to form a key data area of variable shape, size, and position. An example key data area 205B is shown in FIG. 3 to define a circular area. The user can control the position of the frame overlay area with respect to the key data area as mentioned above.

The view comparison component 301 performs a pixel-by-pixel comparison of the data stored in the frame overlay area 304 of the display memory 203 with the designated key data value. The pixel-by-pixel comparison is performed by the view comparison component 301 during transmission of data from the display memory 203 to the display component 105. With respect to FIG. 3, data is transmitted from the display memory 203 to the view comparison component 301 as indicated by an arrow 307. The view comparison component 301 performs the pixel-by-pixel comparison of the data stored in the frame overlay area 304. If the data stored in the frame overlay area 304 for a given pixel is equal to the designated key data value, the corresponding view data for the given pixel will be used to modify the given pixel data transmitted from the display memory 203. Conversely, if the data stored in the frame overlay area 304 for the given pixel is not equal to the designated key data value, the data stored in the frame overlay area for the given pixel will be retained and the corresponding view data for the given pixel will be discarded or blocked. Once appropriate pixel data modifications are made, the view comparison component 301 transfers the pixel data to the output module 206 of the display controller 103 as indicated by the arrow 309. In this manner, each pixel within the corresponding portion of the display memory 203 that is within the frame overlay area 304 is analyzed and processed by the view comparison component 301. It should be noted that when operating in view mode, the incoming view data is not written to the display memory 203 prior to transmission to the display component 105. Additionally, it should be appreciated that the various components of the display controller 103, as shown in FIG. 3, can be implemented as electronic circuits using logic gates and other known electronic components (e.g., comparators).

With respect to the example of FIG. 3, once processing by the view comparison component 301 is completed for a given frame of view data, the circular portion of the view data that is coincident with the key data 205B has been transmitted to and displayed by the display component 105. Also, in view mode, since the key data 205B is not overwritten in the display memory 203 by the incoming view data, it is not necessary to rewrite the key data 205B between successive frames of the view data.

In view mode, view data can be transmitted from the display data source 101 to the display component 105 in a synchronous manner to avoid visual anomalies. With respect to FIG. 3, arrows 305A and 305B are shown to indicate transmission of a synchronization signal from the display data source 101 to both the display memory 203 and the view comparison component 301. The synchronization signal is used by the display memory 203 and the view comparison component 301 to ensure that view data for a given pixel is compared to the appropriate frame overlay area 304 pixel data during transmission of data from the display memory 203 to the display component 105. For example, in one embodiment, digital video data is transmitted from a digital video camera to an LCD panel in synchronization with a vertical sync signal of the associated digital video stream to avoid visual anomalies. In this embodiment, whenever a vertical sync signal occurs, the frame overlay area 304 pixel data is transmitted from the display memory 203 to the LCD panel. If the transmitted frame area 304 pixel data equals the designated key data, the transmitted frame area 304 pixel data is modified using the corresponding digital video data transmitted from the camera. Additionally, certain embodiments may incorporate timing requirements for how data should be sent from the view comparison component 301 to the display component 105. In these embodiments, the display controller 103 is configured to control the data transmission from the view comparison component 301 to comply with the timing requirements of the display component 105.

In a manner similar to the snapshot mode, one embodiment of the view mode defines the designated key data value as a data value mapped to a color (i.e., RGB value). In this embodiment, the designated key data value is referred to as a key color. In one embodiment, the key color is user specified. Key data specifications (i.e., color value, shape, size, and position in the viewable area of the display component 105) can be specified by the user through the MPU host 107 and stored in internal registers within the display controller 103, as discussed with respect to the snapshot mode. The shape, size, and position of the key data area (i.e., key color area) is variable. Thus, the key data area can be defined to allow the view data to be displayed in any suitable shape (e.g., square, heart, cloverleaf, etc . . . ), size, and position in the viewable area of the display component 105, during either view mode or snapshot mode.

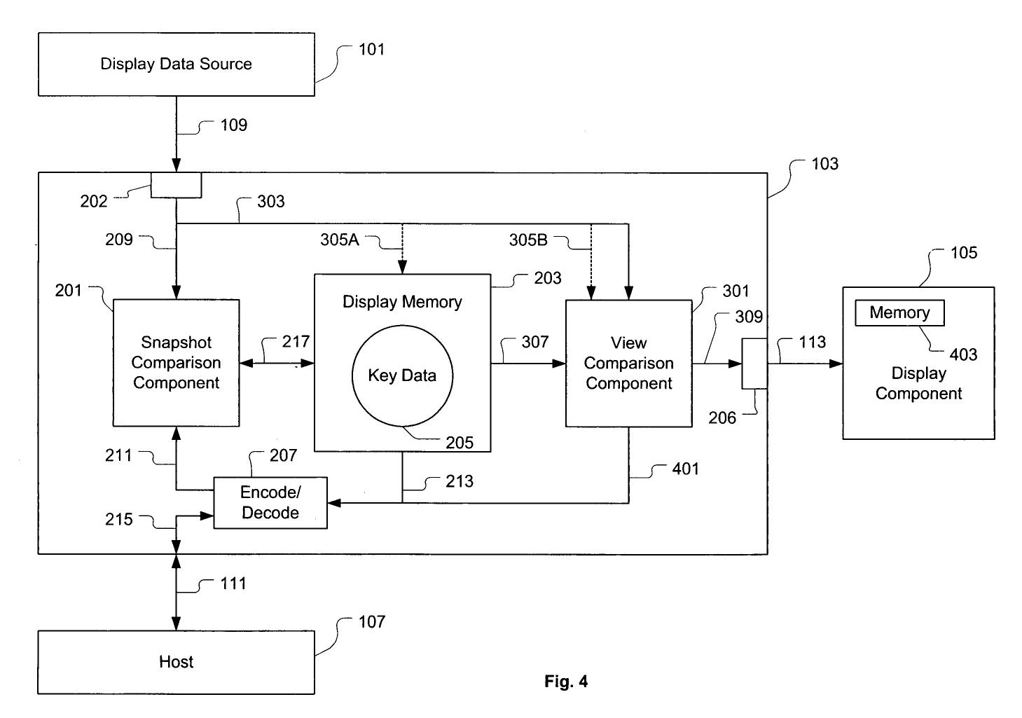

FIG. 4 is an illustration showing architectural features of the display controller 103 used to combine snapshot mode and view mode functionality, in accordance with one embodiment of the present invention. Each of the components incorporated into the display controller 103 of FIG. 4 are configured to function as previously described with respect to the snapshot and view modes of operation. When the display controller 103 is operated in snapshot mode, the view comparison component 301 is inoperable and serves to pass the data transmitted from the display memory 203 to the output module 206 of the display controller 103. Also, when the display controller 103 is operated in view mode, the snapshot comparison component 201 is inoperable, thus ensuring that the key data 205 in display memory 203 is not overwritten.

FIG. 4 includes an additional connection 401 between the view comparison component 301 and the encode/decode device 207. The additional connection 401 allows the display data that is transmitted from the view comparison component 301 to the output module 206 of the display controller 103 to also, or alternatively, be transmitted to the encode/decode device 207. As previously discussed, the encode/decode device 207 can be an encoding component capable of receiving and converting the display data to a digital format suitable for storage. In one embodiment, the encode/decode device 207 is a JPEG CODEC capable of converting the display data to a JPEG format suitable for storage on a computer readable media. After being converted to the digital format suitable for storage, the display data can be transmitted to the MPU host 107, as indicated by arrows 215 and 111, for storage or further processing.

In one embodiment, the display data source 101, MPU host 107, display component 105, and display controller 103 can all be on-board a device. For example, in one embodiment the device is a wireless phone having a digital video camera as the display data source 101, an MPU host 107, an LCD panel as the display component 105, and the display controller 103 of the present invention. Additionally, the display component 105 of the device may have integrated memory capability. FIG. 4, shows a representation of the display component 105 having an integrated memory 403. The display component 105 with integrated memory 403 is capable of refreshing the display from the integrated memory 403. One skilled in the art will appreciate that the use of a display component 105 with integrated memory 403 allows the display data to be transmitted from the view comparison component 301 to the display component 105 without regard to display component timing requirements. Additionally, the embodiment incorporating the display component 105 having integrated memory 403 simplifies the timing interface between the display memory 203, the view comparison component 301, and the display component 105. It should be understood, however, that the display controller 103 of the present invention is equally capable of operating with both a display component 105 having integrated memory 403 and a display component 105 not having integrated memory 403. Additionally, while view comparison component 301 and snapshot comparison component 201 are shown as separate components, it should be appreciated that the two components may be combined into one comparison module. The comparison module includes circuitry configured to perform the functionality of both the view comparison component 301 and the snapshot comparison component 201.

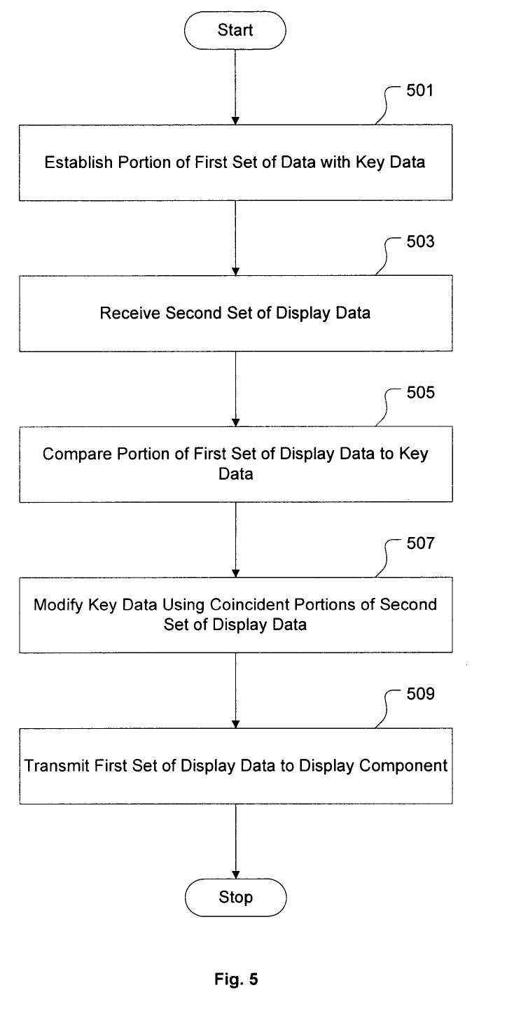

FIG. 5 shows a flowchart illustrating a method for operating an image overlay apparatus, in accordance with one embodiment of the present invention. In one embodiment, the image overlay apparatus is defined as the previously discussed display controller. The method includes an operation 501 for establishing a portion of a first set of data as key data, wherein the key data is defined by a key data value. The key data can be defined to have a variable shape, a variable size, and a variable location within the first set of display data. Consider, for example, that the first set of display data represents display data for an entire viewable area of a display component. In one example, the key data can be defined to represent a heart shape occupying half of the entire viewable area and centered within the entire viewable area. In following, the key data can be defined to represent a picture-in-picture window having a variable shape, a variable size, and a variable location within the viewable area of the display component. As previously discussed with respect to one embodiment, the key data can be assigned a data value mapped to a color (i.e., RGB value). The data value can be user specified. In this embodiment, the key data is referred to as a key color.

The method also includes an operation 503 for receiving a second set of display data. The second set of display data is received from a display data source. As previously discussed with respect to various embodiments, the display data source can be a digital video camera, a digital camera, an electromagnetic transmission, a digital data storage device, or an external MPU host, among others. Therefore, depending on the display data source, the second set of display data can represent either a stand-alone single frame of image data or a frame of image data from a video transmission containing multiple frames of sequenced image data. As such, the second set of display data defines an image having a shape and a size.

The method further includes an operation 505 for comparing a portion of the first set of display data to the key data value. The portion of the first set of display data used in the comparison of operation 505 represents an image overlay area contained within the viewable area of the display component. The image overlay area is defined to correspond to the shape and size of the image represented by the second set of display data. In one embodiment, the display data for each pixel within the portion of the first set of display data is compared to the key data value.

The method continues with an operation 507 for modifying the key data within the portion of the first set of display data using corresponding portions of the second set of display data. In one embodiment, modifying the key data is performed by replacing the key data with the corresponding portions of the second set of display data. In another embodiment, modifying the key data includes performing logical operations using the key data and the corresponding portions of the second set of display data. Examples of the logical operations that can be performed include AND, OR, XOR, AVG, BITSHIFT LEFT, BITSHIFT RIGHT, among others. It should be appreciated by those skilled in the art that modifying the key data can be performed using other logical operations not explicitly exemplified.

In one embodiment, the key data is modified using the corresponding portion of the second set of display data while the first set of display data is contained within a memory. This embodiment corresponds to the snapshot mode of operation as previously discussed. In another embodiment, the key data is modified using the corresponding portion of the second set of display data during a transmission of the first set of display data to the display component. In this embodiment, the corresponding portion of the second set of display is not written to memory. This embodiment corresponds to the view mode of operation as previously discussed. Also in this embodiment, the second set of display data includes a synchronization signal. The synchronization signal can be used to initiate the modification of the key data with the corresponding portion of the second set of display data.

The method also includes an operation 509 for transmitting the first set of display data to a display component. The first set of display data transmitted in the operation 509 represents the first set of display data existing after the modification of the key data using the corresponding portion of the second set of display data as performed in the operation 507. In one embodiment, the display component is a liquid crystal display panel. However, the method of FIG. 5 can be performed using any suitable type of display component. Also, in one embodiment, the first set of display data transmitted in the operation 509 can be received and converted to a digital format suitable for storage. In one example embodiment, the first set of display data can be received by a JPEG CODEC component and converted to a set of JPEG data to be stored on a computer readable media.

The display memory of the present invention contains one set of display data for the entire viewable area of the display component. The key data is written to the display memory to define the portion of the viewable area of the display component that will be used for rendering of the incoming display data. In one embodiment, the portion of the viewable area of the display component used for rendering the incoming display data is a picture-in-picture window. The incoming display data can represent a stand-alone image (e.g., picture) or a sequence of images (e.g., video) to be displayed in the portion of the viewable area of the display component. When operated in snapshot mode, the present invention overwrites the key data within the display memory with the incoming stand-alone image display data, prior to transmission of the display data to the display component. When operated in view mode, the present invention does not require that the display data for the incoming sequence of images be written to the display memory. Rather, in view mode, the present invention uses the display data of the incoming sequence of images to modify the key data as the display data is transmitted to the display component. Thus, in view mode, the key data remains stored in the display memory for use with each incoming frame representing the sequence of images.

In accordance with the foregoing, the present invention does not require the storage of additional display data for common pixels. Thus, the present invention reduces the amount of required memory. For example, consider a device incorporating a 100×100 pixel picture-in-picture window displaying an image on a display panel at 16 bits-per-pixel. Without the present invention, the memory will need to store display data for the entire display panel, including the display area to be overlayed by the picture-in-picture window. In addition, without the present invention, the memory will need to store display data for the picture-in-picture window. The present invention does not require storage of additional display data for the pixels defining the display area to be occupied by the picture-in-picture window. Therefore, with the present invention, the memory requirements are reduced by approximately 19.5 KBytes, which may be significant for a handheld device having limited computational capabilities.

Also, since storage of additional display data is not required for a given pixel, the present invention alleviates the need to have separate functionality for determining which portion of memory to retrieve data from for the given pixel. Due to the reduced memory capacity and access requirements afforded by the present invention, savings can be realized in terms of device size, device power consumption, and device cost. Also, by eliminating the need to read from display memory more than once for a given pixel, the present invention provides improved device performance in terms of operating speed.

While this invention has been described in terms of several embodiments, it will be appreciated that those skilled in the art upon reading the preceding specifications and studying the drawings will realize various alterations, additions, permutations and equivalents thereof. It is therefore intended that the present invention includes all such alterations, additions, permutations, and equivalents as fall within the true spirit and scope of the invention.

1. An image overlay apparatus, comprising:
a memory for storing a first set of display data, the first set of display data including a set of key data associated with a key data value;
an input for receiving a second set of display data;
an output for transmitting a set of output display data; and
a comparison component configured to compare a portion of the first set of display data to the key data value to determine whether the portion of the first set of display data is to be modified with a corresponding portion of the second set of display data.

2. An image overlay apparatus as recited in claim 1, wherein the comparison component is configured to modify the portion of the first set of display data with the corresponding portion of the second set of display data during a transmission of the first set of display data to the output.

3. An image overlay apparatus as recited in claim 2, wherein the second set of display data represents multiple frames of image data transmitted from a camera.

4. An image overlay apparatus as recited in claim 3, wherein the second set of display data includes a synchronization signal, the comparison component defined to use the synchronization signal for determining when to start comparing the portion of the first set of display data to the key data value.

5. An image overlay apparatus as recited in claim 1, further comprising:
a liquid crystal display (LCD) panel, the LCD panel configured to receive the set of output display data, wherein the LCD panel includes a memory region.

6. An image overlay apparatus as recited in claim 1, wherein the key data value is a single color value.

7. An image overlay apparatus as recited in claim 1, wherein the set of key data is defined to occupy a variable size, a variable shape, and a variable location within the first set of display data.

8. An image overlay apparatus as recited in claim 1, wherein the set of key data defines a picture-in-picture window.

9. An image overlay apparatus as recited in claim 1, wherein the comparison component is configured to modify the portion of the first set of display data with the corresponding portion of the second set of display data prior to a transmission of the first set of display data to the output.

10. An image overlay apparatus as recited in claim 1, further comprising:
an encoding component capable of receiving the set of output display data and converting the set of output display data to a digital format suitable for storage.

11. An image overlay apparatus as recited in claim 1, wherein modifying the portion of the first set of display data includes replacing the portion of the first set of display data with the corresponding portion of the second set of display data.

12. An image overlay apparatus as recited in claim 1, wherein modifying the portion of the first set of display data includes performing a logical operation using the portion of the first set of display data and the corresponding portion of the second set of display data.

13. A display controller, comprising:
a memory region configured to store display data, the display data having key-data integrated therein; and
comparison circuitry configured to receive both image overlay data from a source external to the memory region and the display data from the memory region according to a synchronization signal, the comparison circuitry further configured to modify the key data with the image overlay data during transmission of the display data to a display panel.

14. A display controller as recited in claim 13, wherein the image overlay data is a video stream.

15. A display controller as recited in claim 13, wherein the comparison circuitry is configured to compare the display data to a key data value to identify a location of the key data within the display data.

16. A display controller as recited in claim 13, wherein the key data is defined as a single color value.

17. A display controller as recited in claim 13, wherein the key data defines a picture-in-picture window.

18. A display controller as recited in claim 13, further comprising:
an encoding component capable of receiving the display data having the key data modified with the image overlay data, the encoding component configured to convert the display data to a digital format suitable for storage.

19. A display controller as recited in claim 13, wherein modifying the key data includes replacing the key data with the image overlay data.

20. A display controller as recited in claim 13, wherein modifying the key data includes performing a logical operation using the key data and the image overlay data.

21. A method for operating an image overlay apparatus, comprising:
establishing a first portion of a first set of display data with key data, the key data being defined by a key data value;
receiving a second set of display data, the second set of display data defining an image having a shape and a size;
comparing a second portion of the first set of display data to the key data value, the second portion of the first set of display data representing the shape and the size of the image defined by the second set of display data;
modifying the key data within the first portion of the first set of display data with corresponding portions of the second set of display data; and
transmitting the first set of display data to a display component.

22. A method for operating an image overlay apparatus as recited in claim 21, wherein modifying the key data with corresponding portions of the second set of display data is performed with the first set of display data contained within a memory.

23. A method for operating an image overlay apparatus as recited in claim 22, wherein the second set of display data represents a single frame of image data.

24. A method for operating an image overlay apparatus as recited in claim 21, wherein modifying the key data with corresponding portions of the second set of display data is performed during the transmission of the first set of display data to the display component.

25. A method for operating an image overlay apparatus as recited in claim 24, wherein the second set of display data represents a frame of image data from a video transmission.

26. A method for operating an image overlay apparatus as recited in claim 21, wherein the method operation of modifying the key data within the first portion of the first set of display data with corresponding portions of the second set of display data includes detecting a synchronization signal.

27. A method for operating an image overlay apparatus as recited in claim 21, wherein establishing the first portion of the first set of display data with key data is capable of allowing the first portion to have a variable shape, a variable size, and a variable location within the first set of display data.

28. A method for operating an image overlay apparatus as recited in claim 21, wherein the key data defines a picture-in-picture window.

29. A method for operating an image overlay apparatus as recited in claim 21, wherein the key data is represented as a single color value.

30. A method for operating an image overlay apparatus as recited in claim 21, further comprising:
receiving the first set of display data to be provided to the display component; and
converting the first set of display data to a digital format suitable for storage.

31. A method for operating an image overlay apparatus as recited in claim 21, wherein modifying the key data includes replacing the key data with the corresponding portions of the second set of display data.

32. A method for operating an image overlay apparatus as recited in claim 21, wherein modifying the key data includes performing a logical operation using the key data and the corresponding portions of the second set of display data.
